(19) United States
(12) Patent Application Publication
(10) Pub. No.: US 2008/0231261 A1
(43) Pub. Date: Sep. 25, 2008

(54) Hall-type sensor for measuring linear movements

(75) Inventors: Werner Dengler, Nuziders (AT); Alexander Moosmann, Dornbirn (AT)

Correspondence Address: K.F. ROSS P.C., 5683 RIVERDALE AVENUE, SUITE 203 BOX 900, BRONX, NY, 10471-0900, US

(73) Assignee: Hirschmann Automotive GmbH

(21) Appl. No.: 11/796,127

(22) Filed: Apr. 26, 2007

(30) Foreign Application Priority Data
Apr. 27, 2006 (DE) 102006025493.7

(51) Int. Cl. G01B 7/02

(52) U.S. Cl. 324/207.2

(57) ABSTRACT

A Hall-effect sensor assembly (1) for measuring linear movements and a Hall-effect sensor (3) as well as at least one magnet (4) that moves relative to the Hall-effect sensor (3) or vice versa, where according to the invention two magnets (4 and 5) are provided at a predetermined spacing and between the magnets (4 and 5) there is a spacer (6) of magnetically conductive material.

The invention relates to a Hall-effect sensor assembly according to the features of the preamble of claim 1.

Such Hall-effect sensor assemblies designed for measuring linear or rotational movements are known in principle.

In addition, in particular high-precision measuring systems are known that, however, are costly and are based on other technologies such as inductive path measurement, for example.

Furthermore, in the prior art the linear path measurements using Hall-effect sensors are limited to short distances (typically up to 20 mm).

In order to detect linear movements (path measurements) over larger distances by means of Hall magnetic circuit systems having closed magnetic circuits, complicated sensor systems are necessary that disadvantageously require a large installation space.

The object of the invention, therefore, is to provide a Hall-effect sensor assembly designed for measuring linear movements that avoids the above-described disadvantages and is designed for allowing longer measuring distances in a simple and economical manner.

This object is achieved by the features of claim 1.

According to the invention, two magnets are situated at a specified distance from one another, and a spacer made of a magnetically conductive material is provided between the magnets. The main focus of the invention, therefore, is on the target to be measured. The target refers to the measured object or a portion of the measured object (such as an inner core, for example) that generates the measurable magnetic field, the measured object according to the invention being composed of three parts. Two of these parts are the two magnets that are situated at a specified distance from one another, preferably provided at the ends of the linear measurement range. The additional part is a spacer, made of a magnetically conductive material, that is provided for extending the magnetic field and preferably in direct contact with the magnets (magnetic sources). In the alignment of the magnets a different direction of orientation is crucial. Thus a north and/or a south pole must be formed on the ends of the target (measured object).

The magnets are made as permanent magnets, electro-magnets, or plastic-composite magnets in a manner known per se. The plastic-composite magnets are a plastic material in which a magnetizable material (iron particles, for example) may be incorporated. This material mix may be sintered to achieve a particularly high strength for such a plastic-composite magnet.

The invention thus offers the advantage that, compared to the sensors known from the prior art, no closed magnetic circuit is necessary. In addition, due to the very small space requirements the sensor (Hall probe) and the target may be integrated very easily into an overall system. Furthermore, the invention allows a particularly simple geometric design of the measured object. A further advantage is that, for example, for a circular or oval cross-sectional shape of the target the overall sensor system is insensitive to rotation, and the target as the core of the object to be measured may rotate about its own axis of symmetry without the linear measured value changing, thus resulting in a display error. In addition, the sensor system according to the invention allows a favorable temperature response, i.e. compensation for temperature influences. Complete compensation within the three parts of the target is possible by correct selection of materials for the auxiliary parts (permeability and temperature coefficient).

In one refinement of the invention, the spacer is made of a solid material or is hollow. These alternatives allow the spacer to be modified as a function of the installation space conditions and also with regard to manufacture and subsequent assembly of the spacer in the installation space. When the spacer is made of a solid material, it can withstand higher forces when it is integrated into a movable or stationary part of a measuring system, for example. This resistance to high pressures is particularly important when the spacer is extrusion-coated by the part of the measuring system that is manufactured in a plastic injection molding process. With regard to weight reduction it is advantageous for the spacer to have a hollow, in particular tubular design. The hollow design of the spacer economizes material, and therefore weight. Tubular design has the further advantage that a narrow, oblong shape is provided, thus allowing the sensor system according to the invention to be integrated into the target. The cross section in its axial extension remains the same, or may be variable. Thus, conical or even curved spacers are conceivable. Accordingly, the shape and the volume of the two magnets may be the same or different.

In a further embodiment of the invention, it is particularly advantageous that the tubular spacer together with the magnets is mounted on a holding pin. This system composed of a first magnet, an adjacent spacer, and a second magnet may thus be prefabricated as a unit, and this prefabricated assembly may then be attached to the target or integrated therein. The magnets and the spacer mounted on the holding pin may in turn be provided with a sleeve, in particular by extrusion coating or by means of a heat-shrinkable tube, or alternatively, the magnets and the spacer mounted on the holding pin may be inserted into an injection-molding die for producing the movable or stationary part of the measuring system, and then extrusion-coated. In this manner the measuring system together with the sensor system according to the invention is made in one production step.

The entire measuring system thus comprises at least one stationary part and one part that is linearly movable relative thereto, at least the Hall-effect sensor being provided in the stationary part and the two magnets together with their spacer situated therebetween being provided in the movable part. The opposite arrangement is also possible, namely, providing the Hall-effect sensor in the movable part and the remaining elements in the stationary part. The stationary and movable parts in particular are advantageously plastic parts manufactured in the injection molding process. In this manner the installation space for both the measuring system and the Hall-effect sensor may be integrated into these parts so that after the parts are manufactured, either the particular elements (magnets and spacer or Hall-effect sensor, for example) are already integrated, or installation spaces are available in which these elements may be inserted. The desired measuring range, i.e. the length of the linear measurement range, may be adjusted depending on the longitudinal extension of the spacer and also the longitudinal extension of the two magnets. Because of the mode of operation of the sensor system according to the invention, the measurement range extends approximately from the axial center of the first magnet to the axial center of the second magnet, but may deviate slightly therefrom in the other two directions.

Analog output voltages may be used as output signals from the sensor system. It is also possible to provide an interface for the sensor system, to which voltage- or current-dependent pulse width-modulated signals are sent.

The spacer is preferably made of steel, but may also be a ferrite (for example, a ferromagnetic material). It is made of a solid material, but may also be designed as a sleeve or the like.

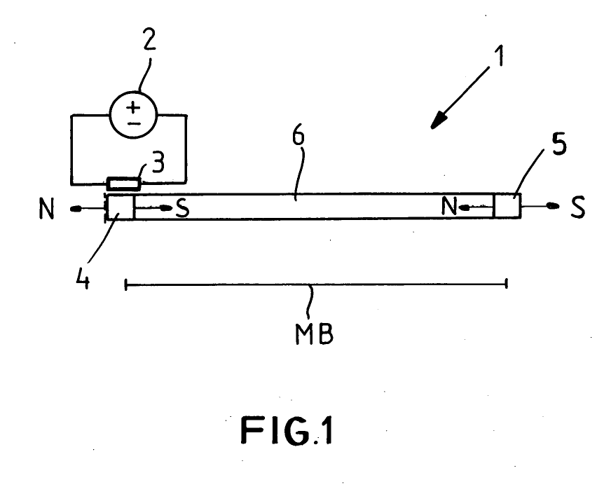

Illustrated embodiments of the invention are shown in detail in FIGS. 1 through 5. A sensor system 1 includes a measuring instrument 2 in a manner known as such that is connected to a Hall-effect sensor 3. The measured object (target) comprises two magnets 4 and 5 that are spaced from each other and held apart by a spacer 6 made of a magnetically conductive material. For this purpose, the magnets 4 and 5 are provided and attached at the ends of the spacer 6 and fixed in place there by an adhesive or locking connection, for example. In other words, the magnets 4 and 5 are mounted on the end of the linear measurement range extending from the outer left edge of the magnet 4 to the outer right edge of the magnet 5.

The measurement is performed by the fact that the measured object, comprising the three parts 4, 5, and 6, either is stationary and the Hall-effect sensor 3 is moved relative thereto, or vice versa.

Because of the mode of operation of the sensor system 1, the measurement range (MB) extends approximately from the axial center of the first magnet 4 to the axial center of the second magnet 5, but may deviate slightly therefrom in the other two directions.

FIG. 1 shows that the left magnet 4 is aligned with its north pole (N) pointing to the left and its south pole (S) pointing to the right. The same applies for the right magnet 5, in which the north pole (N) points to the left and the south pole (S) points to the right. It is noted that the sensor system 1 according to the invention also functions when the alignments of the north pole and south pole are the opposite for the two magnets 4 and 5, as in the case, for example, in which the left magnet has the north pole (N) pointing to the left and the south pole (S) to the right, while for the right magnet 5 the south pole (S) points to the left and the north pole (N) points to the right.

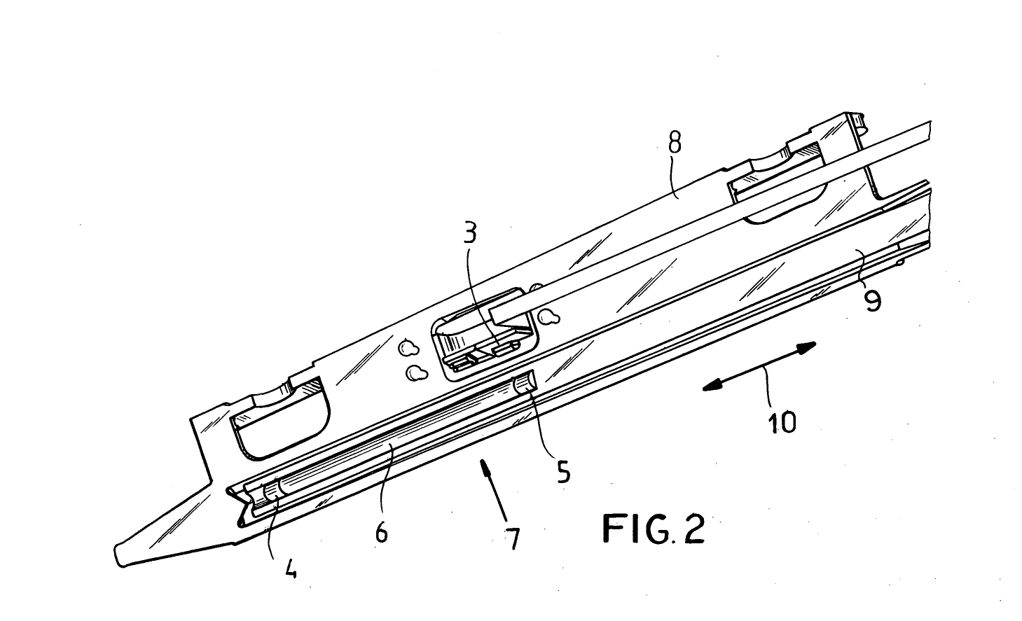

In one application of the sensor system 1 according to the invention as shown in FIG. 1, a measuring system 7 is shown in FIG. 2 in which the principal measuring system 1 is integrated according to FIG. 1. In this measuring system 7 for measuring linear relative movements between a stationary part 8 and a movable part 9 in the direction of movement 10, the Hall-effect sensor 3 is integrated into the stationary part 8, whereas the target that comprises magnets 4 and 5 and the spacer 6 is integrated into the tubular movable part 9. The tubular movable part 9 may thus be moved in the direction of movement 10 relative to the stationary part 8, that has a corresponding seat for the movable part 9. The measuring system 7 according to FIG. 2 is in an end position in which the second magnet 5 is approximately at the level of the Hall-effect sensor 3. When the movable part 9 moves out of the holding space in the stationary part 8, the spacer 6 slides past the Hall-effect sensor 3 until the first magnet 4 passes by at approximately the level of the Hall-effect sensor 3. In this manner the entire measurement range of the sensor system is traversed, for which purpose corresponding stops (not illustrated here) are advantageously present on the parts 8 and 9 in order to mechanically limit the stroke in the direction of movement 10. In FIG. 2, one of these stops is implemented by the fact that the movable part 9 cannot be moved further into the seat in the stationary part 8 because it has come to rest with its end at the corresponding stop in the stationary part 8. For such a measuring system 7 according to FIG. 2, measurement ranges of approximately 45 to 50 mm, for example, in the direction of movement 10 may be achieved so that, for example, the spacer 6 that in this case likewise has a tubular design has a corresponding length. The spacer 6 used in the application example according to FIG. 2 is either a rod (made of solid material) with the magnets 4 and 5 attached (glued, for example) to the end faces thereof, or is a tube for the purpose of weight reduction, in which case the tubular spacer 6 has a hollow interior.

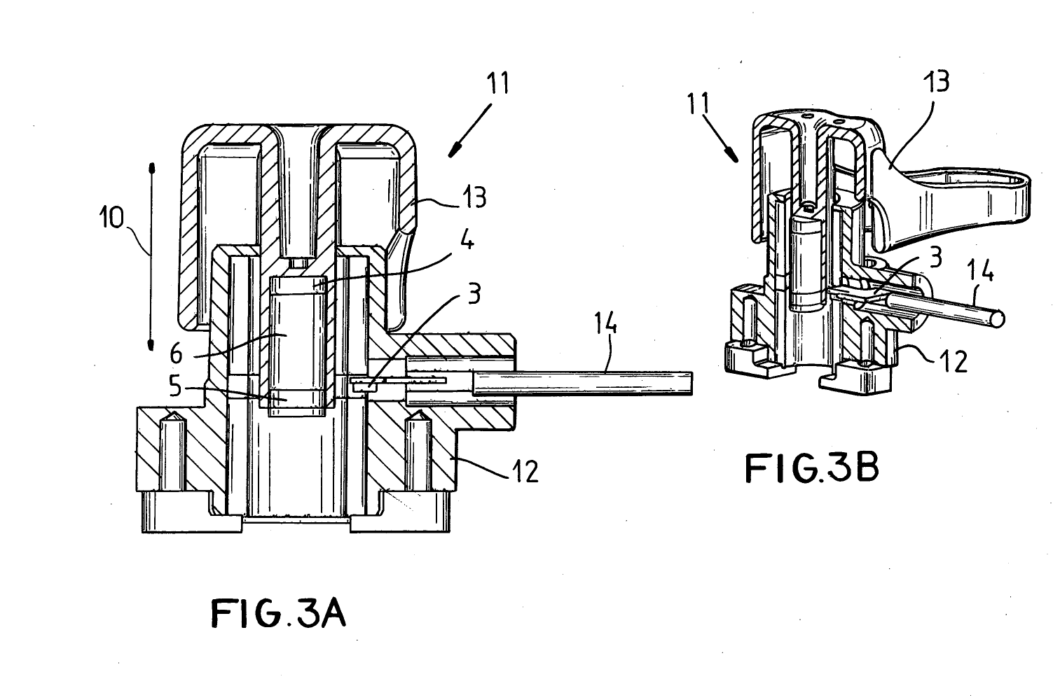

FIGS. 3 through 5 show a further example for the measurement of linear movements, in this case in the approximate range of 20 to 25 mm. The measuring device 11 in FIG. 3 once again comprises at least one stationary part 12 and at least one movable part 13 that may be linearly moved relative to one another in the direction of movement 10. The sensor system according to the invention, having the magnets 4 and 5 and the spacer 6 therebetween, is provided in the movable part 13, whereas the Hall-effect sensor 3 is accommodated in a corresponding installation space in the stationary part 12. In this embodiment the Hall-effect sensor 3 is mounted on a printed circuit board on which additional electronic parts (for signal evaluation or signal conversion, for example) may be provided, the signals from the Hall-effect sensor 3 being delivered via a cable 14 to an unillustrated evaluation unit. In this embodiment the two parts 12 and 13 are plastic injection-molded parts, where after manufacture of the part 12 an installation space is created in them in which the Hall-effect sensor 3 is inserted. The part of the cable 14 together with the printed circuit board and the Hall-effect sensor 3 mounted thereon inserted in this installation space may once again be extrusion-coated with plastic to allow the cable to fit and be fixed in the installation space of the part 12, thereby providing protection from mechanical damage. The parts 4, 5, and 6 may be mounted at that location after the part 13 is manufactured, or alternatively the elements 4, 5, and 6 may be integrated during manufacture of the part 13. With regard to movement of the parts 12, 13 relative to one another in the direction of movement 10, the description for the application example according to FIG. 2 applies; namely, end stops may be present that limit the measurement range of the sensor system according to the invention. Such a linear displacement path may also be permitted between the involved parts such that the sensor system 1 leaves the measurement range.

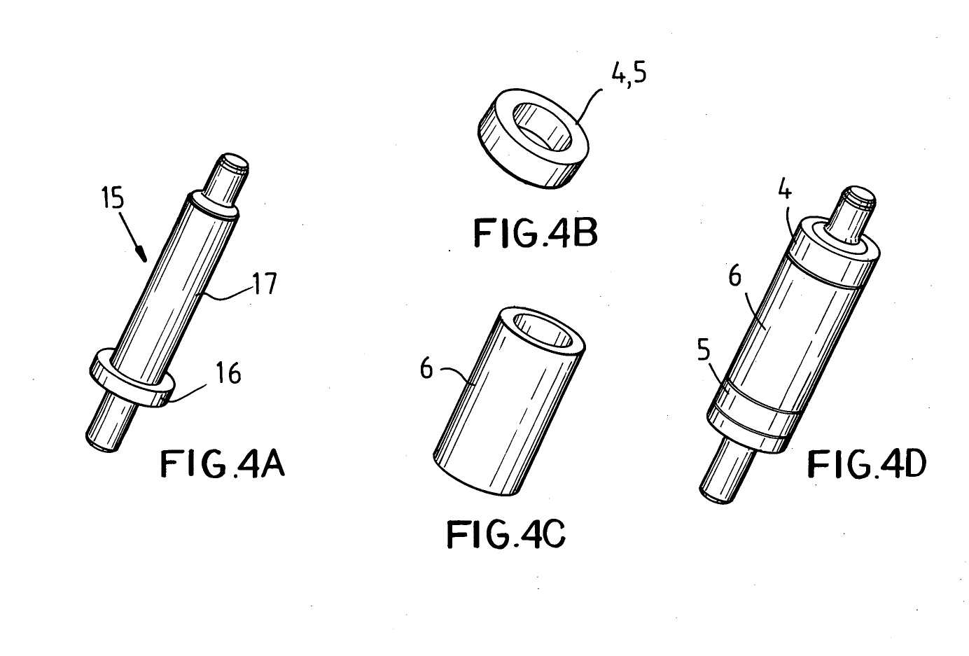

FIG. 4 shows the two magnets 4 and 5 in addition to the spacer 6, in this case having a tubular design, that may be mounted on a correspondingly shaped holding pin 15. The holding pin 15, likewise a plastic injected-molded part, for example, has a disk-shaped shoulder 16. First the one magnet 4, then the spacer 6, and then the second magnet 5 are set on the shoulder. The parts 4 through 6 on the correspondingly shaped shaft 17 of the holding pin 15 may be movably or stationarily mounted (by gluing, for example). The prefabricated unit illustrated on the far right in FIG. 4 may be provided with a jacket (by extrusion coating or application of a heat-shrinkable tube, for example), or inserted in this form into a tool, the tool for the movable part 13 (or the stationary part 12) being produced by plastic extrusion. These parts 4 through 6 thus form a unit together with one of the parts 12 or 13 of the measuring system 11, so that the sensor system 1 according to the invention as shown in FIG. 1 may be easily integrated into existing components.

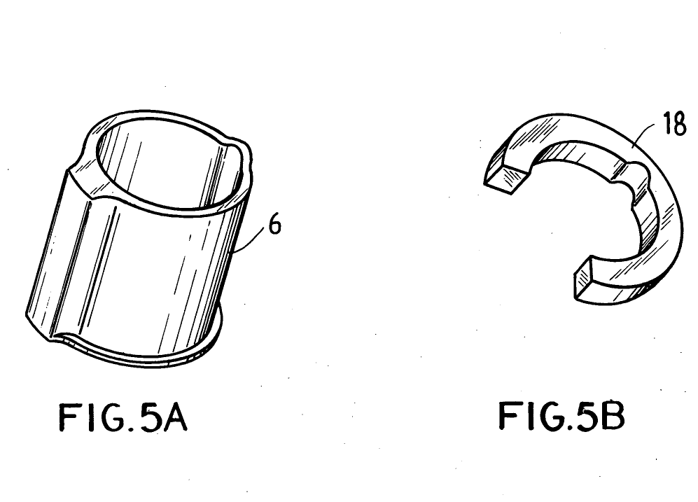

The left side of FIG. 5 shows that the spacer 6 once again has a tubular design, except that in this case it has an asymmetrical cross section. As the result of projections, grooves, or the like, the spacer 6 may thus be inserted into the part 12 or 13 in a guided manner.

The right side of FIG. 5 shows a spacer ring 18 made of a magnetically nonconductive material such as plastic, for example, that may be fitted between the magnet 4 or 5 and the spacer 6, or between the magnet 4 or 5 and the surrounding part in order to compensate for tolerances, for example.

The dimensions referenced with regard to the above measuring systems 7 and 11 (linear measurement ranges) are examples, and may vary depending on the application. This variation may be specified by an axial length of the magnets 4 and 5 and also by the axial length of the spacer 6. In addition, the relative axial length ratios of the axial lengths of the magnets 4 and 5 to the spacer 6 in the preceding figures are only examples, and may likewise vary. Thus, the axial length of a magnet 4 and 5 may be exactly the same as the axial length of the spacer 6, although it is also possible for the axial length of the magnets 4 and 5 to exceed the axial length of the spacer 6, in particular to greatly exceed same.

### REFERENCE NUMERAL LIST

1 sensor assembly
2 measuring instrument
3 Hall-effect sensor
4 first magnet
5 second magnet
6 spacer
7 sensor assembly
8 fixed part
9 movable part
10 movement direction
11 further sensor assembly
12 fixed part
13 movable part
14 cable
15 shoulder
17 shaft
18 spacer ring

1. A Hall-effect sensor assembly for measuring linear movements and a Hall-effect sensor as well as at least one magnet that moves relative to the Hall-effect sensor or vice versa wherein two magnets are provided at a predetermined spacing and between the magnets there is a spacer of magnetically conductive material.

2. The sensor assembly according to claim 1 wherein the magnets are mounted at the ends of a linear measure range.

3. The sensor assembly according to claim 1 wherein the magnets are permanent magnets, electromagnets, or plastic-composite magnets.

4. The sensor assembly according to claim 1 wherein the spacer is steel or a ferrite.

5. The sensor assembly according to claim 1 wherein the spacer is solid or hollow.

6. The sensor assembly according to claim 1 wherein the spacer is tubular.

7. The sensor assembly according to claim 1 wherein the spacer is of axially uniform or varying cross-sectional shape.

8. The sensor assembly according to claim 6 wherein the tubular spacer is mounted on a support pin together with the magnets.

9. The sensor assembly according to claim 8 wherein the support pin is part of another component in which the sensor assembly is mounted.
